(19) United States
(12) Patent Application Publication
(10) Pub. No.: US 2008/0192154 A1
(43) Pub. Date: Aug. 14, 2008

(54) System And Method For Mounting A Television Screen

(76) Inventors: Michel Alain Jean Marie Cadio, Carmel, IN (US); William Hofmann Boss, Indianapolis, IN (US)

Correspondence Address: FLETCHER YODER P.C., 7915 FM 1960 RD. WEST, SUITE 330, HOUSTON, TX, 77070, US

(21) Appl. No.: 11/793,340

(22) PCT Filed: Dec. 29, 2005
(86) PCT No.: PCT/US05/47555

§ 371 Date: Jun. 18, 2007

Related U.S. Application Data
(60) Provisional application No. 60/641,411, filed on Jan. 5, 2005.
(60) Provisional application No. 60/641,673, filed on Jan. 5, 2005.

(51) Int. Cl. H04N 5/645; H04N 5/64

(52) U.S. Cl. 348/836; 361/681; 348/E05.128

(57) ABSTRACT

There is provided a system and method for restricting the movement of a television screen. More specifically, in one embodiment, there is provided a display unit comprising a screen, and a frame member connected without a bezel to the screen, wherein the frame member comprises a first channel configured to receive a bracket and a second channel configured to receive the screen.

### CROSS-REFERENCE TO RELATED APPLICATIONS

This application is a continuation of International PCT Application No. PCT/US2005/047555, filed on Dec. 29, 2005, which claims priority to U.S. Provisional Patent Application No. 60/641,411, and U.S. Provisional Patent Application No. 60/641,673, both filed on Jan. 5, 2005.

### FIELD OF THE INVENTION

The present invention relates generally to systems for projecting video images onto a screen. More specifically, the present invention relates to a system for mounting a television screen within a display unit.

### BACKGROUND OF THE INVENTION

This section is intended to introduce the reader to various aspects of art which may be related to various aspects of the present invention which are described below. This discussion is believed to be helpful in providing the reader with background information to facilitate a better understanding of the various aspects of the present invention. Accordingly, it should be understood that these statements are to be read in this light, and not as admissions of prior art.

Televisions, especially projection televisions, may be built with a large frame around the television screen to mount and maintain the television screen in place. This large frame may disadvantageously enlarge the overall dimensions of the television. In addition, these large frames may disadvantageously create a television with a deep cross section due to the depth of the bezel.

As most people are aware, the screen is one of the most expensive and fragile components of a modern television system, such as a projection television. Often, the screen of a television comprises multiple layers or lenses. For example, most rear projection televisions comprise a screen formed from an inner fresnel surface, which magnifies and disperses the projected image, and an outer lenticular surface, which helps to shape the final shape of the image and may increase the contrast and the viewing angle of the screen.

Both the fresnel surface and the lenticular surface can be damaged during transportation of the television if the screen rubs up against the other components of the television. In addition, if the screen rubs against other components of the television, dust may be generated, which can interfere with the operation of the television

One method of protecting the screen is to tape the edges of the fresnel surface and the lenticular surface together. However, disadvantageously, in the case of a television using a very small frame (i.e. a small television), the small size of the television border may require the tape to be very accurately applied to prevent it from being visible to the user. While applying the tape this accurately is possible, it may be time-consuming and thus expensive. Another method to restrict movement and vibration of the screen is to pinch the screen between a u-shaped part. Disadvantageously, however, this u-shaped part may make the screen more difficult to install and may require an increase in the size of the television frame.

Embodiments of the present invention may address one or more problems set forth above.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The present invention is directed towards a method and a system for mounting a display screen, such as a television screen. Specifically, in one embodiment, there is provided a plastic mounting component mountable to a television frame, wherein the plastic mounting component is configured to protect the television screen by restricting movement and vibration of the of the television screen. In another embodiment, there is provided a thin frame that can be mounted directly onto the upper main section of a display unit, such as a television. This small metallic frame creates a thin screen profile that has no visible front bezel.

### BRIEF DESCRIPTION OF THE DRAWINGS

Advantages of the invention may become apparent upon reading the following detailed description and upon reference to the drawings in which:

FIG. 1 is a diagram illustrating a cross-sectional view of an exemplary frame member in accordance with embodiments of the present invention;

FIG. 2 is a diagram illustrating an exemplary embodiment of a screen assembly in an unbracketed position in accordance with embodiments of the present invention;

FIG. 3 is a diagram illustrating an exemplary screen assembly in a bracketed position in accordance with embodiments of the present invention;

FIG. 4 is a diagram illustrating an exemplary screen assembly in accordance with embodiments of the present invention;

FIG. 5 is a diagram illustrating a perspective view of the back of an exemplary display unit in accordance with embodiments of the present invention;

FIG. 6 is a diagram illustrating a cross-sectional view of an exemplary display unit in accordance with embodiments of the present invention;

FIG. 7 is a diagram illustrating a perspective view of the side of an exemplary display unit in accordance with embodiments of the present invention;

FIG. 8 is a diagram illustrating a front view of an exemplary display unit in accordance with embodiments of the present invention; and

FIG. 9 is a diagram illustrating a cross-sectional view of an exemplary display unit in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, televisions, especially projection televisions, are typically built with a large frame around the television screen to mount and maintain the television screen in place. This large frame may disadvantageously enlarge the overall dimensions of the television. In addition, these large frames may disadvantageously create a television with a deep cross section due to the depth of the bezel. As such, embodiments of the present invention may be directed towards a thin frame for a television that can be mounted on the back end of a television without a bezel.

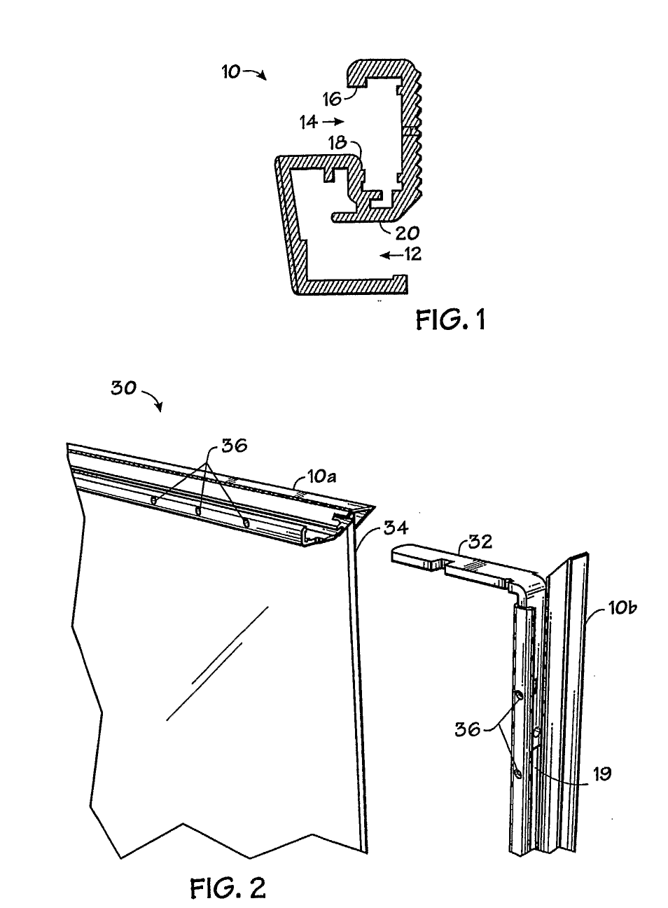

Referring now to FIG. 1, a diagram of a cross-sectional view of an exemplary frame member in accordance with embodiments of the present invention is illustrated and generally designated by a reference numeral 10. In one embodiment, the frame member 10 may comprise and extruded metal component. In alternate embodiments, the frame member 10 may comprise another suitable material.

The frame member 10 may comprise a screen area 12 and a corner bracket area 14. In one embodiment, the frame member 10 is configured in either an “s” or “reverse-s” shape with the screen area 12 occupying one half of the “s” and the corner bracket area 14 occupying the other half. The screen area 12 may be configured to receive and mount a television screen. For example, the screen area 12 is configured to mount a rear projection television screen. In one embodiment, the screen area is a generally “unshaped” channel configured to frictionally attach to the television screen. Moreover, the corner bracket area 14 may be configured to receive a bracket for mounting multiple sections of the frame member 10 together to frame a screen. In one embodiment, the corner bracket area 14 may also comprise a generally “u-shaped” channel. For example, in the illustrated embodiment, the corner bracket area 14 comprises a generally “u-shaped” channel with retaining areas 16 and 18 configured to retain a bracket (as described further below). Moreover, in some embodiments, such as the embodiment illustrated in FIG. 1, the screen area 12 and the corner bracket area 14 may share a wall, such as wall 20.

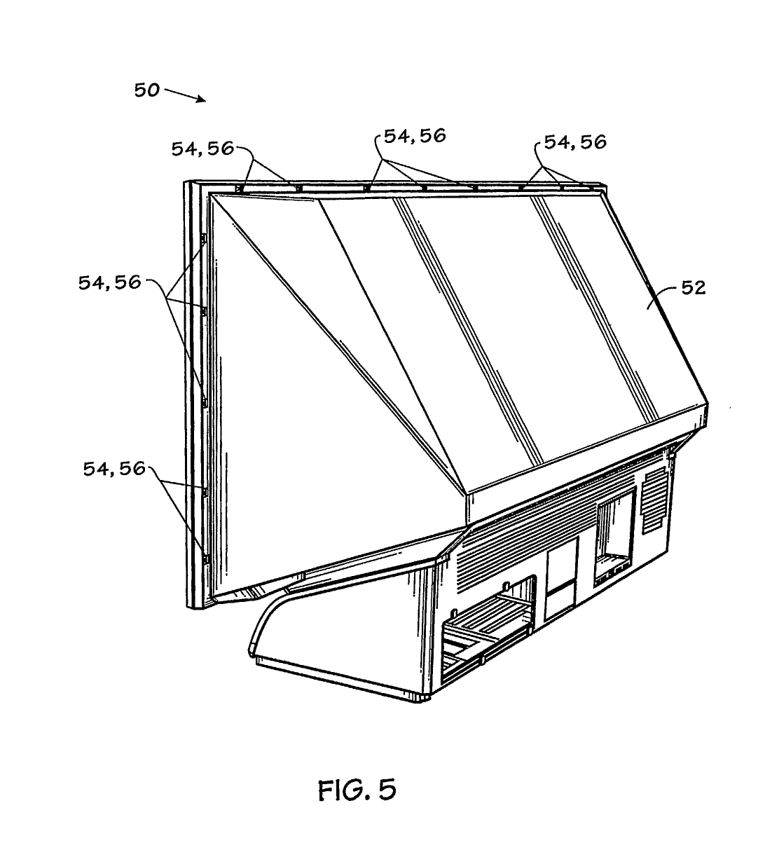

Turning next to FIG. 2, an exemplary screen assembly 30 in an unbracketed position in accordance with embodiments of the present invention is illustrated. The screen assembly 30 may comprise multiple frame members 10a and 10b. The frame members 10a,b may be attached together by a corner bracket 32. As shown in FIG. 2, the corner bracket 32 may attach to the corner bracket area 14 to connect the frame member 10a to the frame member 10b to create a frame for screen 34. In one embodiment, the corner bracket 32 may be frictionally connected to the frame members 10a,b. In another embodiment, the corner bracket 32 may be fastened to the frame members 10a,b by the threaded fasteners disposed through mounting holes 36 in the frame members 10a,b. In alternate embodiments, different fastening mechanisms may be used to fasten the frame members 10a,b to the corner bracket 32. As shown in FIG. 2, the mounting holes 36 may also be employed to mount the screen assembly 30 to an upper main unit 52 of a television (shown in FIG. 5).

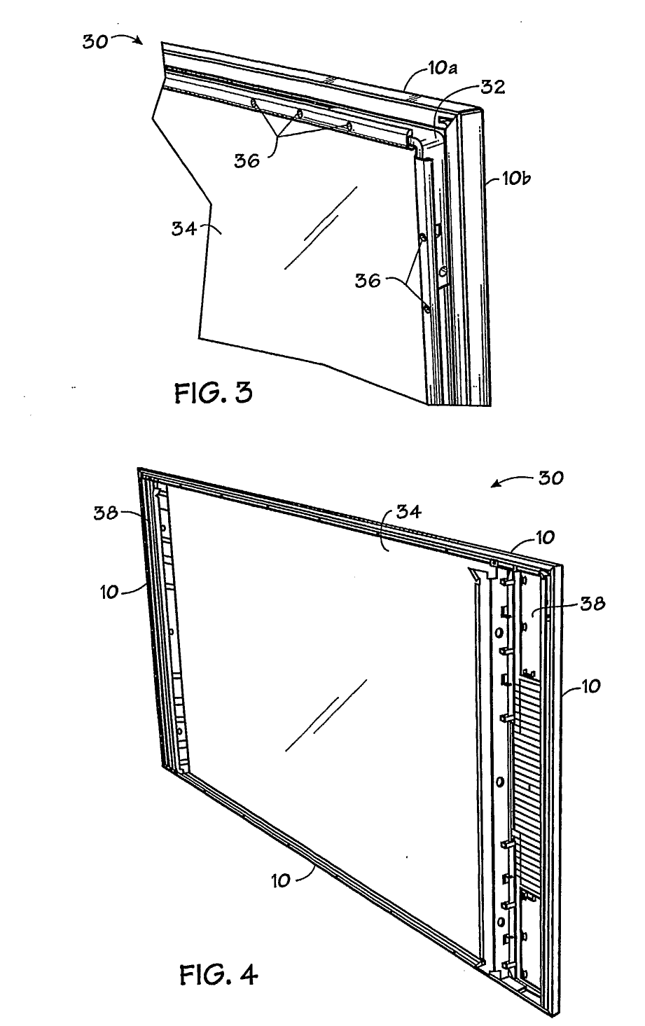

FIG. 3 is a diagram illustrating an exemplary screen assembly in a bracketed position in accordance with embodiments of the present invention. It is important to note that the frame members 10a, b may be configured such that the corner bracket area 14 is open away from the screen assembly 30 (opposite from the direction of opening of the screen area 12) to reduce the chances that metal slivers or burrs will fall into the screen area during assembly.

FIG. 4 is a diagram illustrating an exemplary screen assembly 30 in accordance with embodiments of the present invention. FIG. 4 illustrates four frame members 10 connected together to form a frame for the screen 34. In the embodiment of the screen assembly 30 illustrated in FIG. 4, the screen assembly also comprises two speaker grills 38. The speaker grills 38 may facilitate mounting speakers behind the speaker grills 38 to broadcast sound to accompany the picture being displayed on the screen 34. In this embodiment, the speaker grills 38 may be configured to mount in the screen area 12 of the frame members 10. Those skilled in the art will appreciate that in alternate embodiments the speaker grills 38 may be absent.

Turning next to FIG. 5, a perspective view of the back of an exemplary display unit in accordance with embodiments of the present invention is illustrated and generally designated by a reference numeral 50. In one embodiment, the display unit 50 may comprise a rear projection television system. In another embodiment, the display unit 50 may comprise a Digital Light Processing System (“DLP”). In yet another embodiment, the display unit 50 may comprise a flat panel display, such as a plasma screen or an LCD panel.

In addition to the screen assembly 30, the display unit 50 may also comprise the upper main unit 52. The upper main unit 52 may comprise image production components such as projectors, as well as electrical control components for the display unit 52. The upper main unit 52 may be mounted to the screen assembly 30 by a series of threaded fasteners 56 that may be disposed through upper main mounting holes 54 and the mounting holes 36 (shown in FIGS. 2 and 3). In one embodiment, the upper main mounting holes 54 may comprise internally threaded mounting holes. Those skilled in the art will appreciate that the threaded fasteners 56 are merely one example of a suitable mounting technique. In alternate embodiments, alternate mounting hardware or techniques may be employed.

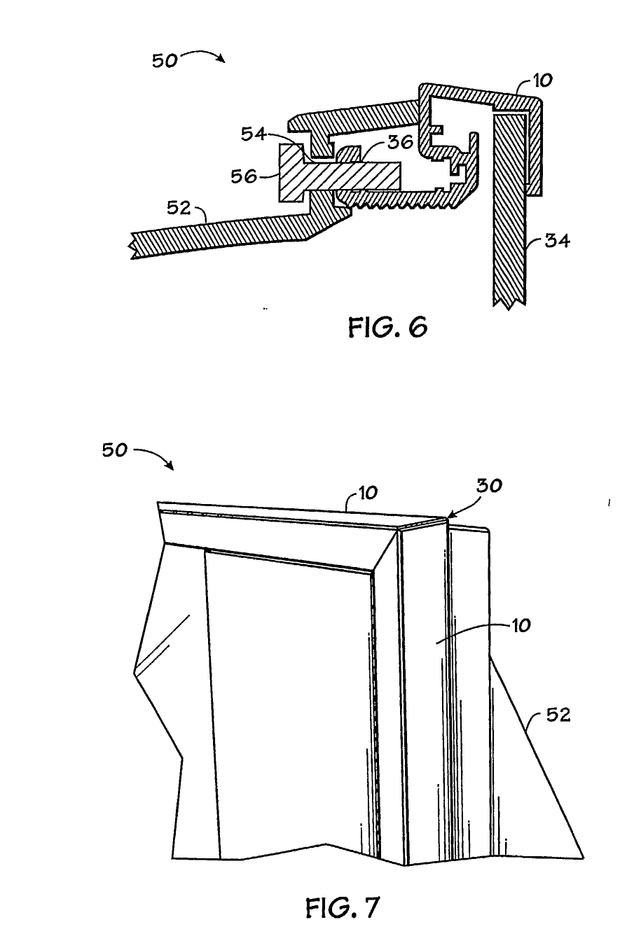

FIG. 6 illustrates a cross-sectional view of an exemplary display unit 50 in accordance with embodiments of the present invention. As FIG. 6 illustrates, the threaded fastener 56 may be disposed through the upper main mounting hole 54 and through the mounting hole 36 to fasten the frame member 10 to the upper main unit 52. As described above, in one embodiment, the upper main mounting holes 54 and the mounting holes 36 may comprise internally threaded mounting holes.

Turning next to FIG. 7, a perspective view of the side of the exemplary display unit 50 is illustrated. As shown in FIG. 7, the screen assembly 30 has a relatively thin cross-sectional depth. Further, as shown in FIG. 8, a front view of the exemplary display unit 50 in accordance with embodiment of the present invention, the display unit 50 has no visible cabinet or front bezel around the frame members 10.

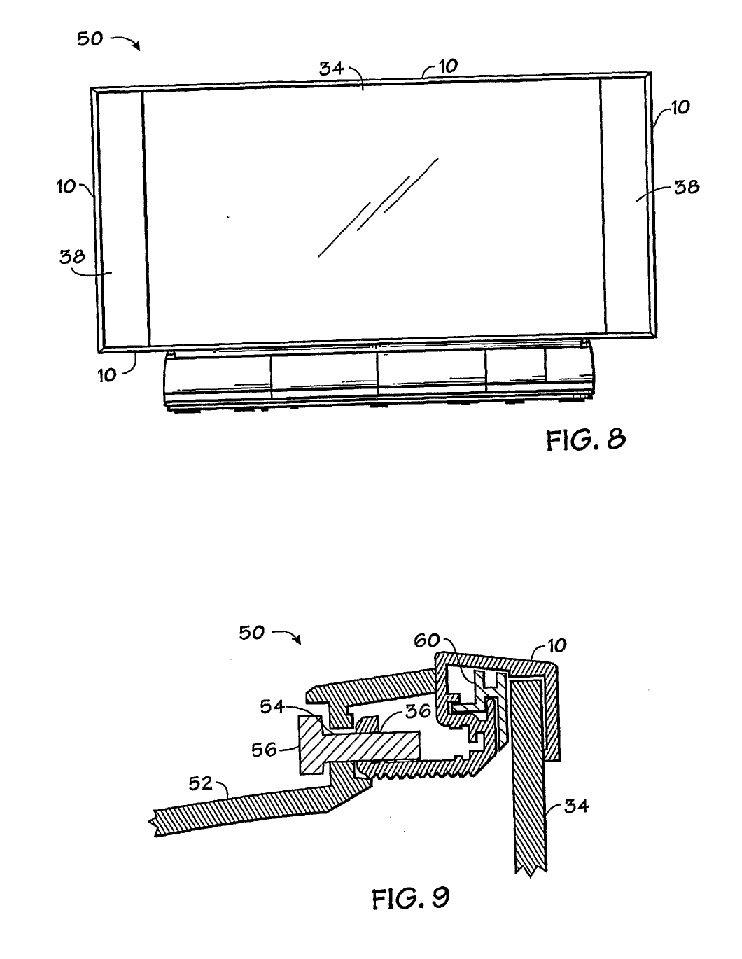

Next, FIG. 9 illustrates a cross-sectional view of the exemplary display unit 50 in accordance with embodiments of the present invention. As described above in regard to FIG. 5, the display unit 50 may comprise the upper main unit 52, the frame member 10, and the screen 34. Further, the upper main unit 52 may be fastened to the frame member 10 by a threaded fastener 56. In this embodiment, the threaded fastener 56 may be disposed through mounting holes 54 and 36 located in the upper main unit 52 and the frame member 10, respectively. Those skilled in the art will appreciate that alternate embodiments may employ different fastening techniques.

The display unit 50 may also comprise a plastic mounting component 60. As illustrated in FIG. 9, the plastic mounting component may be mounted or fastened to the frame member 10. In one embodiment, the plastic mounting component 60 may be fastened to the frame member 10 by frictional contact. In another embodiment, the plastic mounting component 60 may be affixed to the frame member 10 with an adhesive.

Those skilled in the art will appreciate that the plastic mounting component 60 may be installed into the frame member 10 before the screen 34 is mounted. In other words, the plastic mounting component 60 does not need to be affixed to the screen 34 before the screen 34 is mounted in the frame member 10. In this way, the plastic mounting component is relatively easy and inexpensive to install compared with mounting components or tapes that must be affixed to the screen 34 prior to installation.

The plastic mounting component 60 may comprise any one of a number suitable materials that are either soft or have a low coefficient of friction. For example, in one embodiment the plastic mounting component 60 may be comprised of nylon. In another embodiment, the plastic mounting component 60 may be comprised of low density polyethylene. Moreover, in one embodiment, the plastic mounting component 60 may be an extruded plastic mounting component. However, in alternate embodiments, different production techniques may be used for the plastic mounting component 60.

Those skilled in the art will appreciate that the plastic mounting component 60 may protect an area of the inside of the screen 34 from damage by preventing the screen 34 from coming into contact with the frame member 10. In one embodiment, the plastic mounting component may protect an area of the fresnel surface of the screen 34. In addition, by restricting movement of the screen 34, the plastic mounting component may prevent the screen 34 from rubbing against other parts of the display unit 50, which may create dust inside the display unit 50. Those skilled in the art will appreciate that dust inside the display unit 50 is undesirable because it can interfere with the image projection and is not typically correctable by the customer.

Those skilled in the art will also appreciate that the plastic mounting component 60 may be configured such that it does not block the inside ray path from the image projector within the upper main unit 52. For example, the plastic mounting component 60 may be mounted within the overscan region of the display unit 50.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A display unit comprising:
a screen; and
a frame member connected without a bezel to the screen, wherein the frame member comprises a first channel configured to receive a bracket and a second channel configured to receive the screen.

2. The display unit of claim 1, wherein the first channel and the second channel share a wall.

3. The display unit of claim 1, wherein the frame member comprises a single piece of metal.

4. The display unit of claim 1, wherein the frame member comprises a single piece of extruded metal.

5. The display unit of claim 1, wherein the first channel is configured to open in a direction generally opposite from the direction of opening of the second channel.

6. The display unit of claim 1, wherein the frame member is configured to have a generally s shape.

7. The display unit of claim 1, comprising another frame member, wherein the another frame member is coupled to the frame member by the bracket.

8. The display unit of claim 1, wherein the display unit comprises a projection television.

9. The display unit of claim 1, wherein the display unit comprises a digital light processing system.

10. A method of manufacturing a display unit comprising:
(a) providing a screen;
(b) attaching a screen area of a frame member to the display screen; and
(c) attaching a corner bracket to a corner bracket area of the frame member.

11. The method of claim 10, comprising:
(d) attaching the corner bracket to another frame member.

12. The method of claim 10, wherein attaching the screen area comprises attaching the screen area of an extruded metal frame bracket.

13. The method of claim 10, comprising:
(d) attaching a mounting component to the frame member before attaching the screen area of the frame member to the screen.

14. The method of claim 14, wherein attaching the frame member to an upper main unit comprising attaching the frame member to an upper main unit with a threaded fastener.

15. The method of claim 10, wherein the steps are performed in the recited order.

16. A display unit comprising:
a frame member;
a screen in contact with the frame member; and
a mounting component coupled to the frame member, wherein the mounting component is configured to prevent the screen from touching the frame member.

17. The display unit of claim 16, wherein the mounting component comprises nylon.

18. The display unit of claim 16, wherein the mounting component is contained within an overscan region of the display unit.

19. The display unit of claim 16, wherein the mounting component is coupled to the frame member by frictional contact.

20. The display unit of claim 16, wherein the mounting component is configured to prevent a fresnel surface of the screen from touching the frame member.
